(19) United States
(12) Patent Application Publication
(10) Pub. No.: US 2026/0188900 A1
(43) Pub. Date: Jul. 2, 2026

(54) PHASE-SHIFTING DEVICE AND FORMATION METHOD THEREOF, AND LIQUID CRYSTAL ANTENNA

(71) Applicant: Chengdu Tianma Micro-Electronics Co.,Ltd., Chengdu (CN)

(72) Inventors: Zuocai YANG, Chengdu (CN); Yunhua LIU, Chengdu (CN); Qinyi DUAN, Chengdu (CN); Baiquan LIN, Chengdu (CN); Zhenyu JIA, Chengdu (CN); Xiaonan HAN, Chengdu (CN); Yifan XING, Chengdu (CN)

(21) Appl. No.: 19/236,385

(22) Filed: Jun. 12, 2025

(30) Foreign Application Priority Data
Dec. 31, 2024 (CN) 202411997285.0

(51) Int. Cl. H01Q 3/36; H01P 1/00; H01Q 9/04

(52) U.S. Cl. CPC H01Q 3/36; H01P 1/00; H01Q 9/0407

(57) ABSTRACT

The present disclosure provides a phase-shifting device, a formation method of the phase-shifting device and a liquid crystal antenna. The phase-shifting device includes a first substrate; a phase shifter on the first substrate, where the phase shifter includes a first portion and a second portion, the second portion is on a side of the first portion away from the first substrate, the phase shifter includes a first side and a second side which are opposite to each other, the first side is a side of the first portion adjacent to the first substrate, and the second side is a side of the second portion away from the first substrate; and further includes a conductive layer on the first substrate, where the conductive layer is in an electrical contact with a part of the first portion.

### CROSS-REFERENCE TO RELATED APPLICATION

The present disclosure claims the priority of Chinese Patent Application No. 202411997285.0, filed on Dec. 31, 2024, the content of which is incorporated herein by reference in its entirety.

### TECHNICAL FIELD

The present disclosure generally relates to the field of liquid crystal antenna technology and, more particularly, relates to a phase-shifting device, a formation method of the phase-shifting device, and a liquid crystal antenna.

### BACKGROUND

Liquid crystal antennas have broad application prospects in the fields of satellite receiving antennas, vehicle-mounted radars, 5G base station antennas and the like. Liquid crystal antennas are new array antennas made by combining existing patch antennas with liquid crystal phase shifters. The liquid crystal phase shifter may adjust effective dielectric constant of a dielectric layer by controlling deflection of liquid crystal molecules, thereby adjusting the phase difference between the input and output of the phase shifter. The phase shifters of the liquid crystal antennas may be configured to be in an array manner, which may increase antenna gain and overall performance.

For large-scale liquid-crystal phase shifter arrays, the conduction performance of the drive signal lines and all phase shifters may be particularly important, which may need to ensure that each unit may be normally conducted, such that operating performance of entire liquid crystal antenna may be desirable.

### SUMMARY

One aspect of the present disclosure provides a display a phase-shifting device. The phase-shifting device includes a first substrate; a phase shifter on the first substrate, where the phase shifter includes a first portion and a second portion, the second portion is on a side of the first portion away from the first substrate, the phase shifter includes a first side and a second side which are opposite to each other, the first side is a side of the first portion adjacent to the first substrate, and the second side is a side of the second portion away from the first substrate; and further includes a conductive layer on the first substrate, where the conductive layer is in an electrical contact with a part of the first portion.

Another aspect of the present disclosure provides a liquid crystal antenna. The liquid crystal antenna includes a phase-shifting device. The phase-shifting device includes a first substrate; a phase shifter on the first substrate, where the phase shifter includes a first portion and a second portion, the second portion is on a side of the first portion away from the first substrate, the phase shifter includes a first side and a second side which are opposite to each other, the first side is a side of the first portion adjacent to the first substrate, and the second side is a side of the second portion away from the first substrate; and a conductive layer on the first substrate, where the conductive layer is in an electrical contact with a part of the first portion. The liquid crystal antenna further includes a second substrate disposed opposite to the first substrate, where the second substrate and the first substrate form a closed space; and a liquid crystal layer between the first substrate and the second substrate.

Another aspect of the present disclosure provides a formation method of a phase-shifting device. The method includes forming a first substrate; forming a phase shifter on the first substrate, where the phase shifter includes a first portion and a second portion, the second portion is on a side of the first portion away from the first substrate, the phase shifter includes a first side and a second side which are opposite to each other, the first side is a side of the first portion adjacent to the first substrate, and the second side is a side of the second portion away from the first substrate; and forming a conductive layer on the first substrate, where the conductive layer is in an electrical contact with a part of the first portion.

Other aspects of the present disclosure may be understood by those skilled in the art in light of the description, the claims, and the drawings of the present disclosure.

### BRIEF DESCRIPTION OF THE DRAWINGS

In order to clearly explain embodiments of the present disclosure or the technical solutions in the existing technology, the drawings required for describing embodiments or the existing technology are briefly introduced hereinafter. Obviously, the drawings in the following description are merely embodiments of the present disclosure. Other drawings may also be obtained by those skilled in the art without any creative work according to provided drawings.

FIGS. 1-2 illustrate structural schematics of a phase-shifting device in the existing technology.

FIGS. 3-7 illustrate structural schematics of a phase-shifting device formation process according to various embodiments of the present disclosure.

FIGS. 8-11 illustrate structural schematics of another phase-shifting device formation process according to various embodiments of the present disclosure.

FIGS. 12-15 illustrate structural schematics of another phase-shifting device formation process according to various embodiments of the present disclosure.

FIGS. 16-18 illustrate structural schematics of another phase-shifting device formation process according to various embodiments of the present disclosure.

FIGS. 19-23 illustrate structural schematics of another phase-shifting device formation process according to various embodiments of the present disclosure.

FIG. 24 illustrates a structural schematics of a liquid crystal antenna according to various embodiments of the present disclosure.

### DETAILED DESCRIPTION

Various exemplary embodiments of the present disclosure are described in detail with reference to accompanying drawings. It should be noted that unless otherwise specifically stated, relative arrangement of components and steps, numerical expressions and numerical values described in embodiments of the present disclosure may not limit the scope of the present disclosure.

The following description of at least one exemplary embodiment may be merely illustrative and may be not intended to limit the present disclosure and corresponding application or use.

Techniques, methods, and devices known to those skilled in the art may not be discussed in detail, but where appropriate, the techniques, methods, and devices should be considered a part of the present disclosure.

In all examples shown and discussed herein, any specific values should be interpreted as merely exemplary and not as a limitation. Therefore, other examples of exemplary embodiments may have different values.

It should be noted that similar numbers and letters may represent similar items in accompanying drawings. Therefore, once an item is defined in a drawing, the item may not need to be further discussed in subsequent drawings.

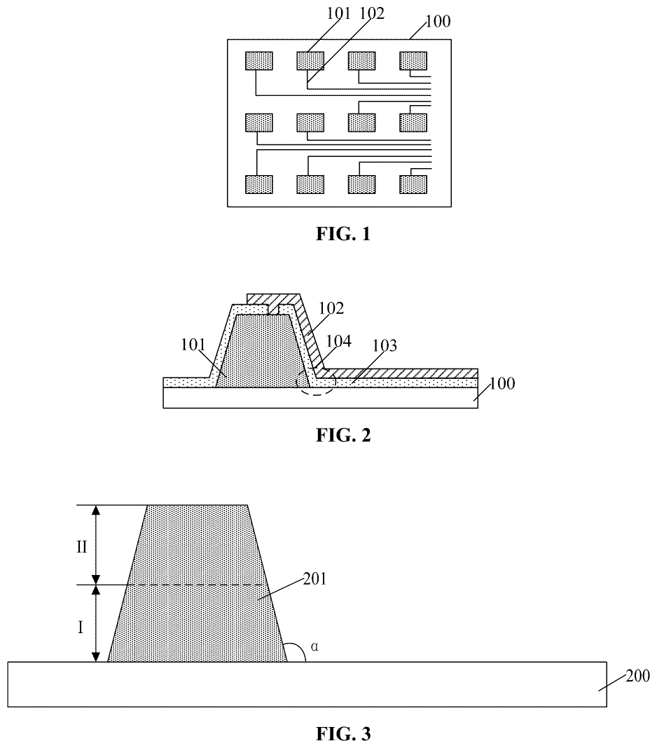

FIGS. 1-2 illustrate structural schematics of a phase-shifting device in the existing technology. FIG. 1 illustrates a top view of a liquid crystal antenna in the existing technology, and FIG. 2 illustrates a cross-sectional structural schematic of a phase-shifting device in the existing technology of FIG. 1. Referring to FIGS. 1-2, the phase-shifting device may include a substrate 100; a phase shifter 101 on the substrate 100; a protective layer 103 on the sidewall surface and top surface of the phase shifter 101 and the surface of the substrate 100; a conductive layer 102 on a part of the protective layer 103, where the conductive layer 102 may extend from the top surface of the phase shifter 101, along one sidewall of the phase shifter 101, to the surface of the substrate 100, and the conductive layer 102 may be electrically connected to the top of the phase shifter 101.

In the phase-shifting device, the material of the phase shifter 101 may include copper, and the material of the protective layer 103 may include a dielectric material. The stress between the protective layer 103 and the phase shifter 101 may be not matched. Therefore, during the formation process, when a relatively large stress (pulling) is generated on the protective layer 103 due to thermal expansion and contraction, the deformation amount of the protective layer 103 may be relatively small. Therefore, the protective layer 103 may be easy to break at the weak position (region 104) where the phase shifter 101 is connected to the substrate 100. When the conductive layer 102 is formed by a wet etching process, the etching liquid may penetrate into the region 104 to etch the conductive layer 102, which may cause the conductive layer 102 to be broken (disconnected), affect the conductive performance of the conductive layer 102 and the phase shifter 101, and further affect the reliability of the phase-shifting device.

To solve above-mentioned problems, the present disclosure provides a phase-shifting device, a formation of the phase-shifting device, and a liquid crystal antenna. The conductive layer may be in electrical contact with the first portion of a part of the phase shifter, such that a stress release window (stress release) may be provided for subsequent film stacking in the region where the conductive layer is in contact with the first portion of the phase shifter, which may avoid the problem of the conductive layer being broken (disconnected) due to the stress mismatch between the conductive layer and other film layers, thereby improving the reliability of the phase-shifting device.

To make above-mentioned objectives, features and beneficial effects of the present disclosure more clearly understood, embodiments of the present disclosure are described in detail below in conjunction with accompanying drawings.

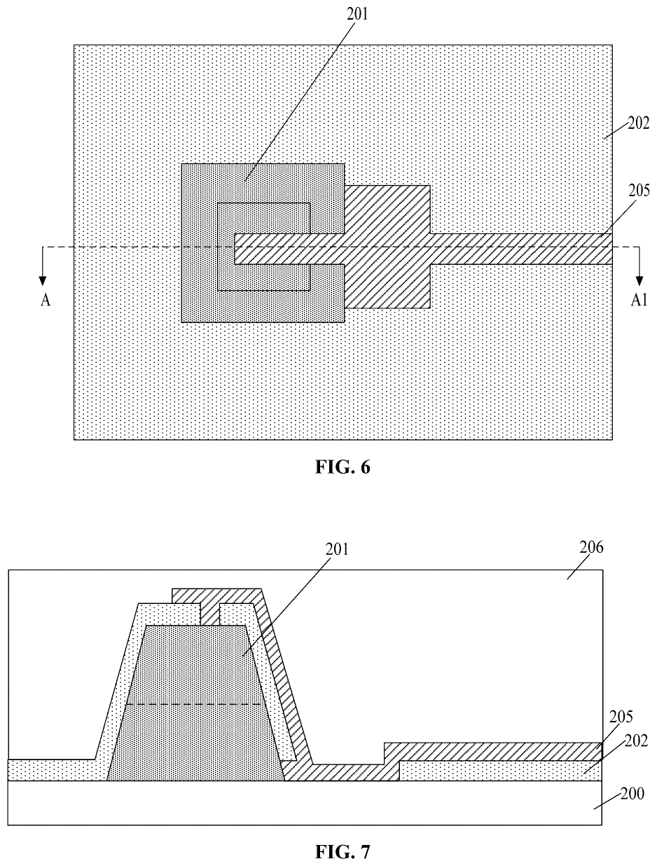

FIGS. 5-6 illustrate structural schematics of a phase shifter according to various embodiments of the present disclosure.

Referring to FIGS. 5-6 , FIG. 5 illustrates a structural schematic of the phase-shifting device along the cross-sectional line AA1 in FIG. 6; and FIG. 6 is a top view of the phase-shifting device in FIG. 5. The phase-shifting device may include a first substrate 200; and a phase shifter 201 on the first substrate 200. The phase shifter 201 may include a first portion I and a second portion II; the second portion II may be on the side of the first portion I away from the first substrate 200; the phase shifter 201 may include a first side and a second side which are opposite to each other; and the first side may be the side of the first portion I adjacent to the first substrate 200, and the second side may be the side of the second portion II away from the first substrate 200. The phase-shifting device may further include a conductive layer 205 on the first substrate 200, where the conductive layer 205 may be in electrical contact with a part of the first portion I.

In the phase-shifting device, the conductive layer 205 may be in electrical contact with the first portion I of a part of the phase shifter 201, such that the region where the conductive layer 205 is in contact with the first portion I of the phase shifter may provide a stress release window for subsequent film stacking, which may avoid the problem of conductive layer being broken (disconnected) due to stress mismatch between the conductive layer 205 and other film layers, thereby improving the reliability of the phase-shifting device.

In one embodiment, the conductive layer 205 may be in electrical contact with a part of the first portion I, which may include that he conductive layer 205 may be in electrical contact with the sidewall of the first portion I. The conductive layer 205 may be in electrical contact with the sidewall of the first portion I, which may increase the electrical contact area between the conductive layer 205 and the phase shifter 201 and improve the conduction yield of the conductive layer 205 and the phase shifter 201.

In one embodiment, the phase-shifting device may further include a protective layer 202 on the side of the first substrate 200 adjacent to the phase shifter 201. The protective layer 202 may cover the phase shifter 201 and a part of the first substrate 200. The protective layer 202 may include a first groove; and the first groove may expose a part of the sidewall surface of the first portion I and further expose a part of the first substrate 200 adjacent to the side of the phase shifter 201. The conductive layer 205 may be on the side of the protective layer 202 away from the first substrate 200 and may be also located in the first groove.

The protective layer 202 may protect the surface of the phase shifter 201 from being damaged during subsequent processes and applications.

In one embodiment, the protective layer 202 may further include a second groove. The second groove may expose a partial surface on the second side; the conductive layer 205 may be also located in the second groove; and the conductive layer 205 may be electrically connected to the second side.

The conductive layer 205 may be electrically connected to the second side. The conductive layer 205 may be also in electrical contact with the sidewall of the first portion I, which may together increase the electrical contact area between the conductive layer 205 and the phase shifter 201 and improve the conduction yield of the conductive layer 205 and the phase shifter 201.

In one embodiment, the width of the phase shifter 201 may be greater than the width of the conductive layer 205. The width of the phase shifter 201 may be relatively large, which may ensure that the conductive layer 205 and the phase shifter 201 are in conduction while having a relatively small resistance, thereby saving the process and material of the conductive layer 205.

In one embodiment, the material of the conductive layer 205 may be different from the material of the phase shifter 201.

In one embodiment, the resistance of the conductive layer 205 material may be greater than the resistance of the phase shifter 201 material. The material of the phase shifter 201 may need to have desirable conduction performance, that is, need to have a relatively small resistance. The material of the conductive layer 205 may need to have a relatively large resistance, which may prevent the signal of the phase shifter 201 from leaking and losing along the path of the conductive layer 205.

In one embodiment, the material of the phase shifter 201 may include a metal including copper molybdenum, copper, gold or silver.

In one embodiment, the material of the conductive layer 205 may include indium tin oxide (ITO), aluminum-doped zinc oxide (AZO) or fluorine-doped tin oxide (FTO). The conductive layer 205 may have desirable conductivity and ductility, which may meet the requirement of thin thickness, not easy to break, and desirable extending (slope) performance while satisfying the conductive performance.

In one embodiment, the material of the protective layer 202 may include a dielectric material. The dielectric constant of the dielectric material may be greater than or equal to 5. The dielectric material may include a silicon-containing material, and the silicon-containing material may include silicon nitride.

In one embodiment, the angle between the sidewall of the phase shifter 201 and the surface of the first substrate 200 may range from 90 degrees to 135 degrees. The sidewall of the phase shifter 201 may have a gentle slope, such that the conductive layer formed subsequently may be extended from the second side of the phase shifter 201, along one sidewall of the phase shifter 201, to the surface of the first substrate 200. Therefore, the film layer formed on the sidewall surface of the phase shifter 201 may have desirable coverage and extending (slope) performance.

As shown in FIG. 7, the phase-shifting device may further include a filling layer 206 on the first substrate 200; and the phase shifter 201 and the conductive layer 205 may be in the filling layer 206. The filling layer 206 may protect the phase shifter 201 and the conductive layer 205 for subsequent processing including encapsulation and the like.

As disclosed above, for the phase-shifting device in one embodiment, referring to FIGS. 5-6, a first groove 203 may be configured in the protective layer 202. The first groove 203 may be configured at the connecting position of the first substrate 200 and the sidewall of the phase shifter 201, and the conductive layer 205 may be in the first groove 203. Therefore, when the phase shifter 201 expands and contracts during the process and causes stress (pulling) on the protective layer 202, the first groove 203 may provide a stress release window for the protective layer 202, such that the protective layer 202 may be not easy to have film breakage due to stress mismatch with the phase shifter 201. Furthermore, the conductive layer 205 may be in direct contact with the first substrate 200 and the sidewall of the phase shifter 201 exposed by the first groove 203, such that the connecting position of the first substrate 200 and the sidewall of the phase shifter 201 may be not easily broken due to uneven film layer stress, thereby improving the reliability of the phase-shifting device.

Accordingly, embodiments of the present disclosure further provide a liquid crystal antenna. Referring to FIGS. 5-6 and 24, the liquid crystal antenna may include the phase-shifting device shown in FIGS. 5-6; a second substrate 210 disposed opposite to the first substrate 200, where the second substrate 210 and the first substrate 200 may form a closed space; and a liquid crystal layer 211 between the first substrate 200 and the second substrate 210.

In one embodiment, the second substrate 210 and the first substrate 200 may be sealed by a sealing layer 212.

The reliability of the phase-shifting device may be desirable, and the liquid crystal antenna formed by the phase-shifting device may have a long service life, and the utilization rate may be improved.

FIGS. 3-7 illustrate structural schematics of a phase-shifting device formation process according to various embodiments of the present disclosure.

Referring to FIG. 3, the first substrate 200 may be provided; the phase shifter 201 may be formed on the first substrate 200; the phase shifter 201 may include the first portion I and the second portion II; the second portion II may be on the side of the first portion I away from the first substrate 200; the phase shifter 201 may include the first side and the second side which are opposite to each other; the first side may be the side of the first portion I adjacent to the first substrate 200; and the second side may be the side of the second portion II away from the first substrate 200.

In one embodiment, the angle α between the sidewall of the phase shifter 201 and the surface of the first substrate 200 may be in the range of 90 degrees to 135 degrees. The sidewall of the phase shifter 201 may have a gentle slope, such that the conductive layer formed subsequently may be extended from the second side of the phase shifter 201, along one sidewall of the phase shifter 201, to the surface of the first substrate 200. Therefore, the film layer formed on the sidewall surface of the phase shifter 201 may have desirable coverage and extending (slope) performance.

The cross-sectional shape of the phase shifter 201 along the direction perpendicular to the surface of the first substrate 200 may include a rectangle or a trapezoid; or at least one side of the cross-sectional shape may have an angle α with the first substrate 200.

In one embodiment, the cross-sectional shape of the phase shifter 201 along the direction perpendicular to the surface of the first substrate 200 may include a trapezoid.

The material of the phase shifter 201 may include metal or metal alloy; the metal may include copper, titanium, gold or silver; and the metal alloy may include copper molybdenum and molybdenum niobium.

In one embodiment, the material of the phase shifter 201 may include copper molybdenum. The copper material may have desirable conduction performance and low resistance which may reduce signal loss. Molybdenum may have desirable adhesion to the glass substrate and used as a connecting layer between the copper metal and the glass substrate to prevent the copper metal device from falling off.

In other embodiments, the copper material with desirable conductivity and low resistance may be replaced by silver or gold.

The method for forming the phase shifter 201 may include forming a metal material layer (not shown in drawings) on the first substrate 200; forming a patterned mask layer (not shown in drawings) on the metal material layer; etching the metal material layer with a patterned mask layer as a mask until the surface of the first substrate 200 is exposed; and forming the phase shifter 201 on the first substrate 200.

In one embodiment, the process of forming the metal material layer may include a physical vapor deposition process.

In one embodiment, the process of etching the metal material layer may include a dry etching process. The dry etching process may be easy to control the etching direction and etching rate and obtain the phase shifter 201 with high dimensional accuracy and desirable morphology.

In one embodiment, the material of the patterned mask layer may include photoresist. In other embodiments, the patterned mask layer may further include a hard mask layer located at the bottom of the photoresist.

In one embodiment, the material of the first substrate 200 may include glass. The glass material may have desirable light transmittance, which may facilitate light to pass through the material of the first substrate 200. Glass may include soda-lime glass, borosilicate glass and/or the like.

In other embodiments, the material of the first substrate may also be resin printed circuit board (PCB), silicon wafer, flexible polyimide (PI) film board and/or the like.

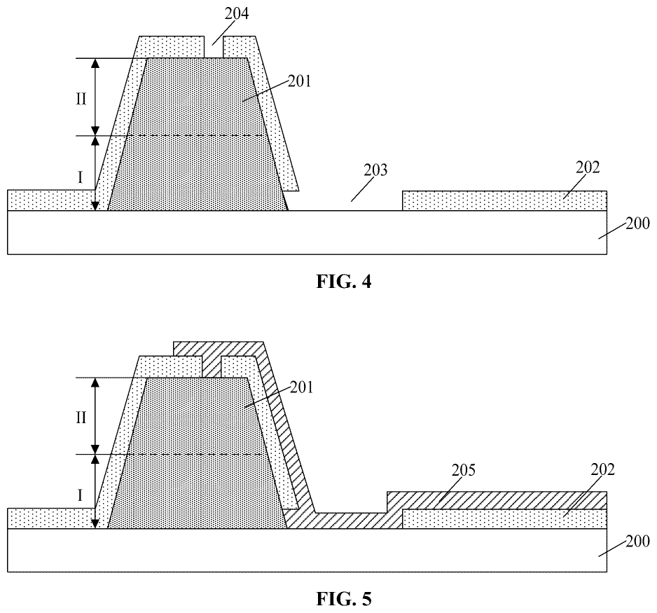

Referring to FIG. 4, the protective layer 202 may be formed on the surface of the first substrate 200, and the sidewall surface and the top surface of the phase shifter 201; the first groove 203 may be formed in the protective layer 202; and the first groove 203 may expose a part of the sidewall surface of the first portion I and also expose a part of the first substrate 200 adjacent to the side of the phase shifter 201.

The protective layer 202 may be used to protect the phase shifter 201 from being damaged by subsequent processes.

Referring FIG. 4, the second groove 204 may be formed in the protective layer 202 on the second side of the phase shifter 201; and the second groove 204 may expose a partial surface of the phase shifter 201 on the second side.

In one embodiment, the first groove 203 and the second groove 204 may be formed simultaneously.

The formation process of the first groove 203, the second groove 204 and the protective layer 202 may include forming the protective material layer (not shown in drawings) on the surface of the first substrate 200, the sidewall surface and the top surface of the phase shifter 201; forming the patterned mask layer (not shown in drawings) on the protective material layer; etching the protective material layer with the patterned mask layer as a mask until the surface of the first substrate 200 is exposed to form the protective layer 202; forming the first groove 203 in the protective layer 202 until the surface of the phase shifter 201 on the second side is exposed; and forming the second groove 204 in the protective layer 202 on the second side of the phase shifter 201.

The process of forming the protective material layer may include a chemical vapor deposition process or an atomic layer deposition process.

In one embodiment, the process of etching the protective material layer may include a dry etching process.

In other embodiments, the first groove and the second groove may be formed in different processes.

The material of the protective layer 202 may include a dielectric material; and the dielectric constant of the dielectric material may be greater than or equal to 5. The copper metal (the phase shifter 201) below the protective layer 202 may be configured for signal phase shifting. Therefore, in order to prevent other metal layers from coupling with the phase shifter 201 to affect the signal, the protective layer 202 which needs to be insulated may be separated. Furthermore, the larger the dielectric constant is, the better the insulation effect is. The protective layer 202 with large dielectric constant may not affect signal.

In one embodiment, the dielectric material may include a silicon-containing material, and the silicon-containing material may include silicon nitride.

In one embodiment, the thickness range of the protective layer 202 may be 500 angstroms to 3000 angstroms.

The depth range of the first groove 203 and the second groove 204 may be same as the thickness range of the protective layer 202.

Referring to FIGS. 5-6, FIG. 5 illustrates a structural schematic of the phase-shifting device along the cross-sectional line AA1 in FIG. 6; and FIG. 6 is a top view of the phase-shifting device in FIG. 5. The conductive layer 205 may be formed on the surface of the protective layer 202 and in the first groove 203. The conductive layer 205 may be in electrical contact with the sidewall of the first portion I. The conductive layer 205 may be on the side of the protective layer 202 away from the first substrate 200.

In one embodiment, the conductive layer 205 may be also formed in the second groove 204 and electrically connected to the second side of the phase shifter 201. The conductive layer 205 may be electrically connected to the second side. The conductive layer 205 may be also electrically in contact with the sidewall of the first portion I, which may together increase the electrical contact area between the conductive layer 205 and the phase shifter 201 and improve the conduction yield of the conductive layer 205 and the phase shifter 201.

The method for forming the conductive layer 205 may include forming the conductive material layer (not shown in drawings) on the surface of the protective layer 202, in the first groove 203 and in the second groove 204; forming the patterned mask layer (not shown in drawings) on the surface of the conductive material layer; etching the conductive material layer with the patterned mask layer as a mask until the surface of the protective layer 202 is exposed; and forming the conductive layer 205 on the surface of the protective layer 202, in the first groove 203 and in the second groove 204.

The conductive layer 205 may be formed in the first groove 203 and fill the first groove 203. In such way, it may prevent the etching solution from penetrating through the first groove 203 to break the conductive material layer when the conductive material layer is etched to form the conductive layer 205 which may result in the problem of poor line breakage in formed conductive layer 205.

In one embodiment, the material of the conductive layer 205 may be different from the material of the phase shifter 201.

In one embodiment, the material resistance of the conductive layer 205 may be greater than the material resistance of the phase shifter 201. The material of the phase shifter 201 may need to have desirable conduction performance, that is, need to have a relatively small resistance. The material of the conductive layer 205 may need to have a relatively large resistance which may prevent the signal of the phase shifter 201 from leaking and losing along the path of the conductive layer 205. Therefore, the material of the conductive layer 205 may be different from the material of the phase shifter 201.

The material of the conductive layer 205 may include a conductive material; and the conductive material may include indium tin oxide (ITO), aluminum-doped zinc oxide (AZO) or fluorine-doped tin oxide (FTO).

In one embodiment, the material of the conductive layer 205 may include indium tin oxide.

In other embodiments, the material of the conductive layer may be same as the material of the phase shifter.

In one embodiment, the process of forming the conductive material layer may include a magnetron sputtering coating process.

In one embodiment, the process of etching the conductive material layer may include a wet etching process.

In one embodiment, the material of the patterned mask layer may include a photoresist. In other embodiments, the patterned mask layer may further include a hard mask layer at the bottom of the photoresist.

In one embodiment, the conductive layer 205 may be on the surface of a part of the protective layer 202; and the conductive layer 205 may extend from the second side of the phase shifter 201, along the sidewall of the phase shifter 201, to the surface of the first substrate 200.

The angle α between the sidewall of the phase shifter 201 and the surface of the first substrate 200 may be in the range of 90 to 135 degrees. The sidewall of the phase shifter 201 may have a gentle slope. When the conductive layer 205 extends from the second side of the phase shifter 201, along the sidewall of the phase shifter 201, to the surface of the first substrate 200, the conductive layer 205 may have desirable coverage and extending (slope) performance on the sidewall surface of the phase shifter 201.

In one embodiment, the first groove 203 may expose at least a part of the sidewall of the first portion I on a side of the phase shifter 201 having the conductive layer 205. That is, when the conductive layer 205 extends from the second side of the phase shifter 201, along the sidewall of the phase shifter 201, to the surface of the first substrate 200, the first groove 203 may be on the extension direction of the conductive layer 205.

FIG. 4 illustrates that the first groove 203 may expose a part of the sidewall of the first portion I on the side of the phase shifter 201.

In other embodiments, the first groove may expose entire sidewall of the first portion on the side of the phase shifter having the conductive layer. In one embodiment, along the extension direction of the conductive layer 205, the width range of the first groove 203 may be greater than or equal to 3 microns.

In one embodiment, the width of the conductive layer 205 may be less than the width of the first groove 203, the material forming the conductive layer may fill the first groove, and the width of the conductive layer 205 may be relatively small, which may save cost while satisfying conductive performance.

The first groove 203 may be in the protective layer 202 and at the connecting position of the first substrate 200 and the sidewall of the phase shifter 201; and the conductive layer 205 may be in the first groove 203. Therefore, when the conductive layer 205 expands and contracts during the process and causes stress (pulling) on the protective layer 202, the first groove 203 may provide a stress release window for the protective layer 202, such that the protective layer 202 may be not easy to cause the film layer to break due to the stress mismatch with the phase shifter 201. In addition, the conductive layer 205 may be in direct contact with the first substrate 200 and the sidewall of the phase shifter 201 exposed by the first groove 203, such that the connecting position of the first substrate 200 and the sidewall of the phase shifter 201 may be not easily broken due to uneven film layer stress, thereby improving the reliability of the phase-shifting device.

In one embodiment, the width of the phase shifter 201 may be greater than the width of the conductive layer 205, which may ensure that the conductive layer 205 and the phase shifter 201 are in conduction while having a relatively small resistance, thereby saving the process and material of the conductive layer 205.

In one embodiment, the width of the phase shifter 201 may be in the range of 30 microns to 100 microns.

In one embodiment, the width of the conductive layer 205 may be in the range of 20 microns to 50 microns.

In one embodiment, the thickness of the conductive layer 205 may be in the range of 500 angstroms to 1500 angstroms.

Referring to FIG. 7, the filling layer 206 may be formed on the first substrate 200; and the phase shifter 201 and the conductive layer 205 may be in the filling layer 206. The filling layer 206 may protect the phase shifter 201 and the conductive layer 205, which may be convenient for subsequent processes including encapsulation and the like.

The material of the filling layer 206 may include resin. The filling layer 206 may be used to improve the flatness and light transmittance of the surface of the first substrate 200 and may have desirable heat resistance and strength to protect the conductive layer 205 from being damaged and improve the service life.

In other embodiments, the filling layer may be not formed on the first substrate.

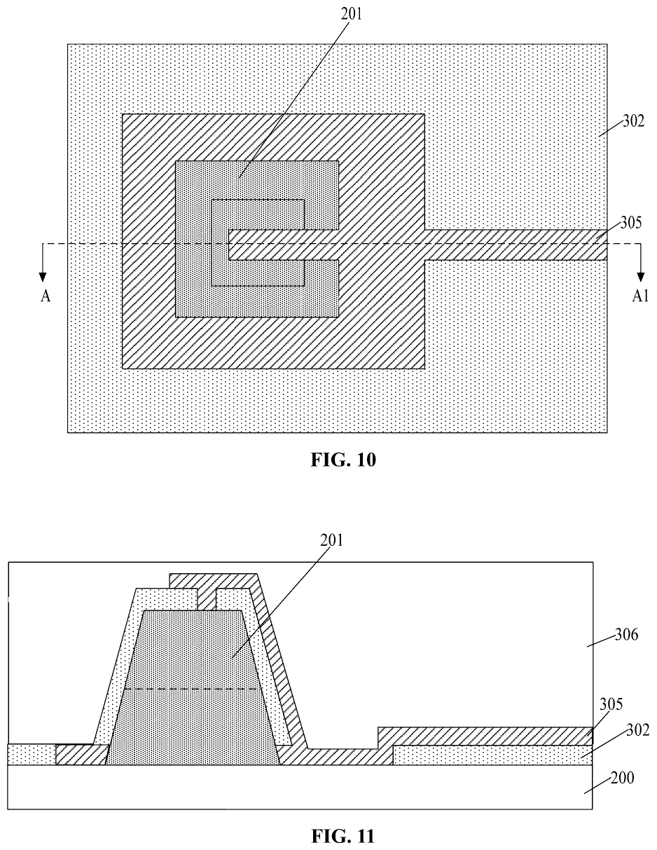

FIGS. 9-10 illustrate structural schematics of another phase-shifting device according to various embodiments of the present disclosure.

Referring to FIGS. 9 and 10, FIG. 9 illustrates a structural schematic of the phase-shifting device along the cross-sectional line AA1 in FIG. 10; and FIG. 10 is a top view of the phase-shifting device in FIG. 9. The phase-shifting device may include the first substrate 200; the phase shifter 201 on the first substrate 200, where the phase shifter 201 may include the first portion I and the second portion II, the second portion II may be on the side of the first portion I away from the first substrate 200, the phase shifter 201 may include the first side and the second side which are opposite to each other, the first side may be the side of the first portion I adjacent to the first substrate 200, and the second side may be the side of the second portion II away from the first substrate 200; and further include the conductive layer 305 on the first substrate 200, where the conductive layer 305 may be in electrical contact with a part of the first portion I.

In the phase-shifting device, the conductive layer 305 may be in electrical contact with the first portion I of a part of the phase shifter. Therefore, the region where the conductive layer 305 is in contact with the first portion I of the phase shifter may provide a stress release window for subsequent film stacking, which may avoid the problem of the conductive layer being broken (disconnected) due to the stress mismatch between the conductive layer 305 and other film layers, thereby improving the reliability of the phase-shifting device.

In one embodiment, the conductive layer 305 may be in electrical contact with a part of the first portion I, which may include that the conductive layer 305 is in electrical contact with the sidewall of the first portion I. The conductive layer 305 may be in electrical contact with the sidewall of the first portion I, which may increase the electrical contact area between the conductive layer 305 and the phase shifter 201 and improve the conduction yield of the conductive layer 305 and the phase shifter 201.

In one embodiment, the phase-shifting device may further include a protective layer 302 on the side of the first substrate 200 adjacent to the phase shifter 201, where the protective layer 302 may cover the phase shifter 201 and a part of the first substrate 200; the protective layer 302 may include the first groove, where the first groove may be in the protective layer 302, expose a part of the sidewall surface of the first portion I and also expose a part of the first substrate 200 adjacent to the side of the phase shifter 201, and the first groove may surround the phase shifter 201; and the conductive layer 305 may be on the side of the protective layer 302 away from the first substrate 200 and may be also located in the first groove.

The protective layer 302 may protect the surface of the phase shifter 201 from being damaged during subsequent processes and applications.

In one embodiment, the protective layer 202 may further include the second groove, the second groove may be in the protective layer 302 on the second side, the second groove may expose a part of the surface of the phase shifter on the second side, the conductive layer 305 may be also located in the second groove, and the conductive layer 305 may be electrically connected to the second side.

The conductive layer 305 may be electrically connected to the second side and also electrically in contact with the sidewall of the first portion I, which may together increase the electrical contact area between the conductive layer 305 and the phase shifter 201 and improve the conduction yield of the conductive layer 305 and the phase shifter 201.

In one embodiment, the conductive layer 305 may be on the surface of a part of the protective layer 302 and extend from the second side of the phase shifter 201, along the sidewall of the phase shifter 201, to the surface of the first substrate 200.

In one embodiment, the material of the phase shifter 201 may include a metal including copper molybdenum, copper, gold or silver.

In one embodiment, the material of the conductive layer 305 may include ITO, AZO or FTO. The conductive layer 305 may have desirable conductivity and ductility, which may meet the requirement of thin thickness, not easy to break, and desirable extending (slope) performance while satisfying the conductive performance.

In one embodiment, the material of the protective layer 302 may include a dielectric material, the dielectric constant of the dielectric material may be greater than or equal to 5, the dielectric material may include a silicon-containing material, and the silicon-containing material may include silicon nitride.

In one embodiment, the angle between the sidewall of the phase shifter 201 and the surface of the first substrate 200 may be in the range of 90 degrees to 135 degrees. The sidewall of the phase shifter 201 may have a gentle slope, such that the conductive layer formed subsequently may be extended from the second side of the phase shifter 201, along one sidewall of the phase shifter 201, to the surface of the first substrate 200. Therefore, the film layer formed on the sidewall surface of the phase shifter 201 may have desirable coverage and extending (slope) performance.

As disclosed above, the conductive layer 305 may be in electrical contact with the first portion I of a part of the phase shifter. Therefore, the region where the conductive layer 305 is in contact with the first portion I of the phase shifter may provide a stress release window for subsequent film stacking, which may avoid the problem of the conductive layer being broken (disconnected) due to the stress mismatch between the conductive layer 305 and other film layers, thereby improving the reliability of the phase-shifting device.

Referring to FIG. 11, the phase-shifting device may further include a filling layer 306 on the first substrate; and the phase shifter 201 and the conductive layer 305 may be in the filling layer 306. The filling layer 306 may protect the phase shifter 201 and the conductive layer 305, which may be convenient for subsequent processes including encapsulation and the like.

In the phase-shifting device, the first groove 303 may be in the protective layer 302, the first groove 303 may be located at the connecting position of the first substrate 200 and the sidewall of the phase shifter 201, and the conductive layer 305 may be in the first groove 303. Therefore, when the conductive layer 305 expands and contracts during the process and causes stress (pulling) on the protective layer 302, the first groove 303 may provide a stress release window for the protective layer 302, such that the protective layer 302 may be not easy to cause the film layer to break due to the stress mismatch with the phase shifter 201. Furthermore, the conductive layer 305 may be in direct contact with the first substrate 200 and the sidewall of the phase shifter 201 exposed by the first groove 303, such that the connecting position of the first substrate 200 and the sidewall of the phase shifter 201 may be not easily broken due to uneven film layer stress, thereby improving the reliability of the phase-shifting device.

Accordingly, embodiments of the present disclosure further provide a liquid crystal antenna. Referring to FIGS. 9-10, the liquid crystal antenna may include the phase-shifting device shown in FIGS. 9-10; the second substrate disposed opposite to the first substrate 200, where the second substrate and the first substrate 200 may form a closed space; and the liquid crystal layer located between the first substrate 200 and the second substrate.

The reliability of the phase-shifting device may be desirable, and the liquid crystal antenna formed by the phase-shifting device may have a long service life and improve the utilization rate.

The structure of the liquid crystal antenna may refer to the structure in FIG. 24.

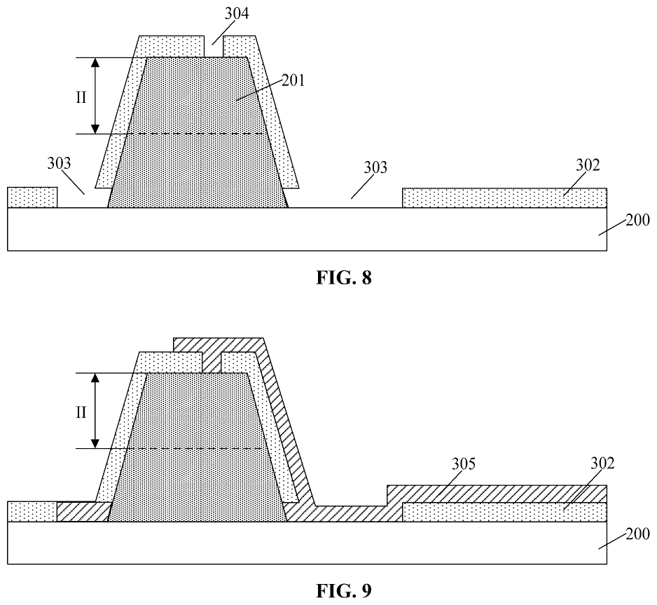

FIGS. 8-11 illustrate structural schematics of another phase-shifting device formation process according to various embodiments of the present disclosure.

Referring to FIG. 8 which is a structural schematic based on FIG. 3, the difference between FIG. 8 and FIG. 4 is that, in one embodiment, the first groove 303 may surround the phase shifter 201.

Referring to FIG. 8, the protective layer 302 may be formed on the surface of the first substrate 200, the sidewall surface and the top surface of the phase shifter 201; the first groove 303 may be formed in the protective layer 302; the first groove may expose a part of the sidewall surface of the first portion I and also expose a part of the first substrate 200 adjacent to the side of the phase shifter 201; the first groove may surround the phase shifter 201; the second groove 304 may be formed in the protective layer 302 on the second side of the phase shifter 201; and the second groove 304 may expose a part of the surface of the phase shifter 201 on the second side.

In FIG. 8, the first groove 303 may expose a part of the sidewall of the first portion I of the phase shifter 201, and the depth of the first groove 303 may be less than the thickness of the first portion I. Therefore, the depth of the first groove 303 may not need to be too large, thereby saving processes.

In other embodiments, the first groove may expose entire sidewall of the first portion of the phase shifter.

The protective layer 303 may be used to protect the phase shifter 201 from being damaged by subsequent processes.

In one embodiment, the first groove 303 and the second groove 304 may be formed simultaneously.

The formation process of the first groove 303, the second groove 304 and the protective layer 302 may include forming the protective material layer (not shown in drawings) on the surface of the first substrate 200, the sidewall surface and the top surface of the phase shifter 201; forming the patterned mask layer (not shown in drawings) on the protective material layer; etching the protective material layer with the patterned mask layer as a mask until the surface of the first substrate 200 is exposed; forming the protective layer 302; forming the first groove 303 in the protective layer 302 until the surface of the phase shifter 201 on the second side is exposed; and forming the second groove 304 in the protective layer 302 on the second side of the phase shifter 201.

The process of forming the protective material layer may include a chemical vapor deposition process or an atomic layer deposition process.

In one embodiment, the process of etching the protective material layer may include a dry etching process.

In other embodiments, the first groove and the second groove may be formed at different processes.

The material of the protective layer 302 may include a dielectric material; and the dielectric constant of the dielectric material may be greater than or equal to 5. The phase shifter 201 (copper metal) may be used for signal phase shifting below the protective layer 302. Therefore, in order to prevent other metal layers from coupling with the phase shifter 201 to affect the signal, an insulating layer may be needed for separation. The larger the dielectric constant of the protective layer 302 is, the better the insulation effect of the protective layer 302 is.

In one embodiment, the dielectric material may include a silicon-containing material, and the silicon-containing material may include silicon nitride.

In one embodiment, the thickness range of the protective layer 302 may be at range of 500 angstroms to 3000 angstroms.

The depth range of the first groove 303 and the second groove 304 may be same as the thickness range of the protective layer 302.

Referring to FIGS. 9-10, FIG. 9 illustrates a structural schematic of the phase-shifting device along the cross-sectional line AA1 in FIG. 10; and FIG. 10 is a top view of the phase-shifting device in FIG. 9. The conductive layer 305 may be formed on the surface of the protective layer 302 and in the first groove 303 and in electrical contact with the sidewall of the first portion I.

In one embodiment, the conductive layer 305 may be also formed in the second groove 304 and electrically connected to the second side of the phase shifter 201.

The conductive layer 305 may be electrically connected to the second side; and electrically in contact with the sidewall of the first portion I, which may together increase the electrical contact area between the conductive layer 305 and the phase shifter 201 and improve the conduction yield of the conductive layer 305 and the phase shifter 201.

The method for forming the conductive layer 305 may include forming the conductive material layer (not shown in drawings) on the surface of the protective layer 302, in the first groove 303 and in the second groove 304; forming the patterned mask layer (not shown in drawings) on the surface of the conductive material layer; etching the conductive material layer using the patterned mask layer as a mask until the surface of the protective layer 302 is exposed; and forming the conductive layer 305 on the surface of the protective layer 302, in the first groove 303 and in the second groove 304.

The conductive layer 305 may be formed in the first groove 303 and fill the first groove 303. In such way, it may prevent the etching solution from penetrating through the first groove 203 to break the conductive material layer when the conductive material layer is etched to form the conductive layer 305 which may result in the problem of poor line breakage in formed conductive layer 305.

The first groove 303 may surround the phase shifter 201, such that the contact area between the conductive layer 305 formed in the first groove 303 and the phase shifter 201 may become larger, which may increase conduction area, reduce contact resistance, and eliminate the breakage problem of the protective layer 302 due to pulling stress caused by thermal expansion and contraction of the conductive layer 305, thereby further avoiding the problem of the conductive layer 305 being broken due to leakage of etching liquid when the conductive layer 305 is formed at the etching process.

In one embodiment, the material of the conductive layer 305 may be different from the material of the phase shifter 201.

The material of the conductive layer 305 may include indium tin oxide (ITO), aluminum-doped zinc oxide (AZO) or fluorine-doped tin oxide (FTO).

In one embodiment, the material of the conductive layer 305 may include indium tin oxide.

In one embodiment, the process of forming the conductive material layer may include a magnetron sputtering coating process.

In one embodiment, the process of etching the conductive material layer may include a wet etching process.

In one embodiment, the material of the patterned mask layer may include photoresist. In other embodiments, the patterned mask layer may further include a hard mask layer at the bottom of the photoresist.

In one embodiment, the conductive layer 305 may be on the surface of a part of the protective layer 302, and the conductive layer 305 may extend from the second side of the phase shifter 201, along a sidewall of the phase shifter 201, to the surface of the first substrate 200.

In one embodiment, along the extension direction of the conductive layer 305, the width range of the first groove 303 may be greater than or equal to 3 microns.

The first groove 303 may be in the protective layer 302; the first groove 303 may be located at the connecting position of the first substrate 200 and the sidewall of the phase shifter 201; and the conductive layer 305 may be in the first groove 303. Therefore, when the conductive layer 305 expands and contracts during the process and causes stress (pulling) on the protective layer 302, the first groove 303 may provide a stress release window for the protective layer 302, such that the protective layer 302 may be not easy to cause the film layer to break due to the stress mismatch with the phase shifter 201. Furthermore, the conductive layer 305 may be in direct contact with the first substrate 200 and the sidewall of the phase shifter 201 exposed by the first groove 303, such that the connecting position of the first substrate 200 and the sidewall of the phase shifter 201 may be not easily broken due to uneven film layer stress, thereby improving the reliability of the phase-shifting device.

In one embodiment, the width of the phase shifter 201 may be in the range of 30 microns to 100 microns.

In one embodiment, the width of the conductive layer 305 may be in the range of 20 microns to 50 microns.

In one embodiment, the thickness of the conductive layer 305 may be in the range of 500 angstroms to 1500 angstroms.

Referring to FIG. 11, the filling layer 306 may be formed on the first substrate 200; and the phase shifter 201 and the conductive layer 305 may be in the filling layer 306. The filling layer 306 may protect the phase shifter 201 and the conductive layer 305 for subsequent processes including encapsulation and the like.

The material of the filling layer 306 may include resin. The filling layer 306 may be used to improve the flatness and light transmittance of the surface of the first substrate 200 and have desirable heat resistance and strength to protect the conductive layer 305 from being damaged and improve the service life.

In other embodiments, the filling layer may be not formed.

FIG. 15 illustrates a structural schematic of another phase shifter according to various embodiments of the present disclosure.

Referring to FIG. 15, the phase-shifting device may include a first substrate 400; a phase shifter 402 on the first substrate 400, where the phase shifter 402 may include the first portion I and the second portion II, the second portion II may be on the side of the first portion I away from the first substrate 400, the phase shifter 402 may include the first side and the second side which are opposite to each other, the first side may be the side of the first portion I adjacent to the first substrate 400, and the second side may be the side of the second portion II away from the first substrate 400; and further include a conductive layer 401 on the first substrate 400, where the conductive layer 401 may be in electrical contact with a part of the first portion I.

In the phase-shifting device, the conductive layer 401 may be in electrical contact with a part of the first portion I of the phase shifter 402. Therefore, the region where the conductive layer 401 is in contact with the first portion I of the phase shifter may provide a stress release window for subsequent film stacking, which may avoid the problem of the conductive layer being broken (disconnected) due to the stress mismatch between the conductive layer 401 and other film layers, thereby improving the reliability of the phase-shifting device.

In one embodiment, the conductive layer 401 may be in electrical contact with a part of the first portion I, which may include that the conductive layer 401 is in electrical contact with the first side of the phase shifter 402. The conductive layer 401 may be in electrical contact with the first side of the phase shifter 402, which may increase the electrical contact area between the conductive layer 401 and the phase shifter 402 and reduce the contact resistance between the conductive layer 401 and the phase shifter 402.

In one embodiment, the conductive layer 401 may be on the side of the first substrate 400 adjacent to the phase shifter 402, and the phase shifter 402 may be on the side of the conductive layer 401 away from the first substrate 400.

In one embodiment, the material of the conductive layer 401 may be different from the material of the phase shifter 402.

In one embodiment, the width of the phase shifter 402 may be greater than the width of the conductive layer 401. The width of the phase shifter 402 may be relatively large, which may ensure that the conductive layer 401 and the phase shifter 402 are in conduction while having a relatively small resistance and save the process and material of the conductive layer 401.

In one embodiment, the ratio of the sheet resistance of the phase shifter 402 to the sheet resistance of the conductive layer 401 may be greater than or equal to 10000.

In one embodiment, the material of the phase shifter 402 may include a metal or a metal alloy, the metal may include copper, gold or silver, and the metal alloy may include copper molybdenum.

In one embodiment, the material of the conductive layer 401 may include a conductive material; and the conductive material may include indium tin oxide, aluminum-doped zinc oxide or fluorine-doped tin oxide. The conductive layer 401 may have desirable conductivity and ductility, which may meet the requirement of thin thickness, not easy to break, and desirable extending (slope) performance while satisfying the conductive performance.

In one embodiment, the phase-shifting device may further include a protective layer 403 covering the surface of the phase shifter 402 and a part of the surface of the conductive layer 401.

In one embodiment, the material of the protective layer 403 may include a dielectric material, the dielectric constant of the dielectric material may be greater than or equal to 5, the dielectric material may include a silicon-containing material, and the silicon-containing material may include silicon nitride.

In one embodiment, the ratio of the sheet resistance of the phase shifter 402 to the sheet resistance of the conductive layer 401 may be greater than or equal to 10000, which may ensure that the phase shifter 402 is in desirable contact with the conductive layer 401 to achieve desirable conduction.

In one embodiment, the angle between the sidewall of the phase shifter 402 and the surface of the first substrate 400 may be in the range of 90 degrees to 135 degrees. The sidewall of the phase shifter 402 may have a gentle slope, such that the protective layer 403 formed subsequently may extend from the second side of the phase shifter 4021, along the sidewall of the phase shifter 402, to the surface of the first substrate 400. Therefore, the film layer formed on the sidewall surface of the phase shifter 402 may have desirable coverage and extending (slope) performance.

In the phase-shifting device, the conductive layer 401 may be on the side of the first substrate 400 adjacent to the phase shifter 402, and the phase shifter 402 may be on the side of the conductive layer 401 away from the first substrate 400. The phase shifter 402 may be in direct contact with the conductive layer 401. The phase shifter 402 and the conductive layer 401 may be both conductive materials having relatively small stress difference. Therefore, when the conductive layer 401 expands and contracts during the process to generate stress (pulling), the film layer may not be broken, thereby improving the reliability of the phase-shifting device.

In one embodiment, the sidewall of the phase shifter 402 may be coplanar with one side of the conductive layer 401, as illustrated in FIG. 15.

In other embodiments, two ends of the conductive layer may protrude from the sidewalls of the phase shifter.

Accordingly, embodiments of the present disclosure further provide a liquid crystal antenna. Referring to FIG. 15, the liquid crystal antenna may include the phase-shifting device shown in FIG. 15; the second substrate disposed opposite to the first substrate 400, where the second substrate and the first substrate 400 form a closed space; and further include the liquid crystal layer between the first substrate 400 and the second substrate.

The phase-shifting device may have desirable reliability, and the liquid crystal antenna formed by the phase-shifting device may have a long service life and improve the utilization rate.

The liquid crystal antenna may refer to the structure in FIG. 24.

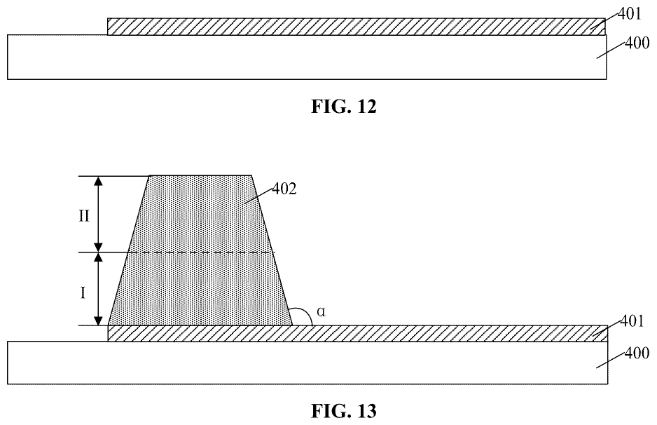

FIGS. 12-15 illustrate structural schematics of another phase-shifting device formation process according to various embodiments of the present disclosure.

Referring to FIG. 12, the first substrate 400 may be provided; and the conductive layer 401 may be formed on the first substrate 400.

In one embodiment, the material of the first substrate 200 may include glass. The glass material may have desirable light transmittance, which may facilitate light to pass through the material of the first substrate 200. The glass may include soda-lime glass or borosilicate glass.

In other embodiments, the material of the first substrate may also be resin PCB board, silicon wafer, flexible PI film board and/or the like.

The method for forming the conductive layer 401 may include forming the conductive material layer (not shown in drawings) on the surface of the first substrate 400; forming the patterned mask layer (not shown in drawings) on the surface of the conductive material layer; etching the conductive material layer with the patterned mask layer as a mask until the surface of the first substrate 400 is exposed; and forming the conductive layer 205 on the surface of the first substrate 400.

The material of the conductive layer 401 may include a conductive material; and the conductive material may include indium tin oxide (ITO), aluminum-doped zinc oxide (AZO) or fluorine-doped tin oxide (FTO).

In one embodiment, the material of the conductive layer 401 may include indium tin oxide.

In one embodiment, the process of forming the conductive material layer may include a magnetron sputtering coating process.

In one embodiment, the process of etching the conductive material layer may include a wet etching process.

In one embodiment, the material of the patterned mask layer may include photoresist. In other embodiments, the patterned mask layer may further include a hard mask layer located at the bottom of the photoresist.

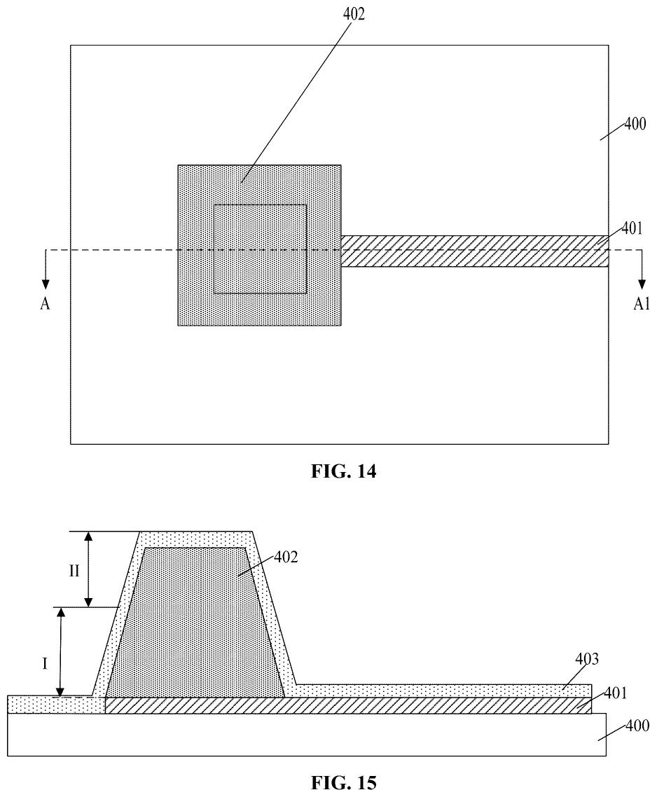

Referring to FIGS. 13-14. FIG. 13 illustrates a structural schematic of the phase-shifting device along the cross-sectional line AA1 in FIG. 14; and FIG. 14 is a top view of the phase-shifting device in FIG. 13. The phase shifter 402 may be formed on the conductive layer 401 and the first substrate 400. The phase shifter 402 may include the first portion I and the second portion II. The second portion II may be on the side of the first portion I away from the first substrate 400. The phase shifter 402 may include the first side and the second side which are opposite to each other. The first side may be the side of the first portion I adjacent to the first substrate 400, and the second side may be the side of the second portion II away from the first substrate 400.

The method for forming the phase shifter 401 may include forming the metal material layer (not shown in drawings) on the first substrate 400 and the conductive layer 401; forming the patterned mask layer (not shown in drawings) on the metal material layer; etching the metal material layer using the patterned mask layer as a mask until the surface of the first substrate 400 and the surface of the conductive layer 401 are exposed; and forming the phase shifter 401 on the first substrate 200.

In one embodiment, the process of forming the metal material layer may include a physical vapor deposition process.

In one embodiment, the process of etching the metal material layer may include a dry etching process. The dry etching process may be easy to control the etching direction and etching rate and obtain the phase shifter 401 with high dimensional accuracy and desirable morphology.

In one embodiment, the material of the patterned mask layer may include photoresist. In other embodiments, the patterned mask layer may further include a hard mask layer at the bottom of the photoresist.

In one embodiment, the angle α between the sidewall of the phase shifter 402 and the surface of the first substrate 400 may be in the range of 90 degrees to 135 degrees. FIGS. 13-14 illustrate the angle α between the sidewall of the phase shifter 402 and the surface of the conductive layer 401. The surface of the conductive layer 401 may be in parallel with the surface of the first substrate 400. The angle α between the sidewall of the phase shifter 402 and the surface of the conductive layer 401 may be characterized as the angle between the sidewall of the phase shifter 402 and the surface of the first substrate 400.

The angle α between the sidewall of the phase shifter 402 and the surface of the first substrate 400 may be in the range of 90 degrees to 135 degrees. The sidewall of the phase shifter 402 may have gentle slope, such that the protective layer formed on the sidewall surface of the phase shifter 402 may have a desirable coverage and extending (slope) performance.

The cross-sectional shape of the phase shifter 402 along the direction perpendicular to the surface of the first substrate 400 may include a rectangle, or a trapezoid; or at least one side of the cross-sectional shape may have the angle α with the first substrate 400.

In one embodiment, the cross-sectional shape of the phase shifter 402 along the direction perpendicular to the surface of the first substrate 400 may include a trapezoid.

In one embodiment, the material of the conductive layer 401 may be different from the material of the phase shifter 402.

The material of the phase shifter 402 may include a metal or a metal alloy, the metal may include copper, gold or silver, and the metal alloy may include copper-molybdenum.

In one embodiment, the material of the phase shifter 201 may include copper-molybdenum.

The copper material may have desirable conduction performance and low resistance which may reduce signal loss. Molybdenum may have desirable adhesion to the glass substrate and used as a connecting layer between the copper metal and the glass substrate to prevent the copper metal device from falling off.

In other embodiments, copper material with desirable conductivity and low resistance may be replaced by silver or gold.

The material of the conductive layer 401 may include a conductive material; and the conductive material may include indium tin oxide (ITO), aluminum-doped zinc oxide (AZO) or fluorine-doped tin oxide (FTO).

In one embodiment, the material of the conductive layer 401 may include indium tin oxide.

In other embodiments, the material of the conductive layer may be same as the material of the phase shifter.

In one embodiment, the width of the phase shifter 402 may be greater than the width of the conductive layer 401.

The conductive layer 401 may be on one side of the first substrate 400 adjacent to the phase shifter 402. In one embodiment, the phase shifter 402 may expose one end of the conductive layer 401 at the bottom of the phase shifter 402, thereby ensuring that the phase shifter 402 and the conductive layer 401 have a relatively large contact area to achieve desirable conduction.

In other embodiments, the phase shifter may not expose one end of the conductive layer at the bottom of the phase shifter.

In one embodiment, the ratio of the sheet resistance of the phase shifter 402 to the sheet resistance of the conductive layer 401 may be greater than or equal to 10000, which may ensure that the phase shifter 402 is in desirable contact with the conductive layer 401 to achieve desirable conduction.

The conductive layer 401 may be on the side of the first substrate 400 adjacent to the phase shifter 402, and the phase shifter 402 may be on the side of the conductive layer 401 away from the first substrate 400. That is, the phase shifter 402 may be above the conductive layer 401, and the phase shifter 402 may be in direct contact with the conductive layer 401. The phase shifter 402 and the conductive layer 401 may be both conductive materials having relatively small stress difference. Therefore, when the conductive layer 401 expands and contracts during the process to generate stress (pulling), the film layer may not be broken, thereby improving the reliability of the phase-shifting device.

Referring to FIG. 15 which is a schematic based on FIG. 13, the protective layer 403 may be formed on the surface of the first substrate 400, the surface of the conductive layer 401, and the sidewall surface and the top surface of the phase shifter 402.

The protective layer 403 may be used to protect the phase shifter 402 and the conductive layer 401 from being damaged in subsequent processes.

The process of forming the protective layer 403 may include a chemical vapor deposition process or an atomic layer deposition process.

The material of the protective layer 403 may include a dielectric material, and the dielectric constant of the dielectric material may be greater than or equal to 5. The copper metal (the phase shifter 402) below the protective layer 403 may be used for signal phase shifting. Therefore, in order to prevent other metal layers from coupling with the phase shifter 402 to affect the signal, the protective layer 403 which needs to be insulated may be separated. The larger the dielectric constant is, the better the insulation effect is. The protective layer 403 with large dielectric constant may not affect signal.

In one embodiment, the dielectric material may include a silicon-containing material, and the silicon-containing material may include silicon nitride.

In one embodiment, the thickness of the protective layer 403 may be in the range of 500 angstroms to 3000 angstroms.

In one embodiment, the formation method may further include forming a filling layer (not shown in drawings) on the first substrate 400; and the phase shifter 402 and the conductive layer 401 may be in the filling layer.

The material of the filling layer may include resin. The filling layer may be used to improve the flatness and light transmittance of the surface of the first substrate 400 and have desirable heat resistance and strength to protect the conductive layer 401 from being damaged and improve the service life.

In other embodiments, the filling layer may be not formed.

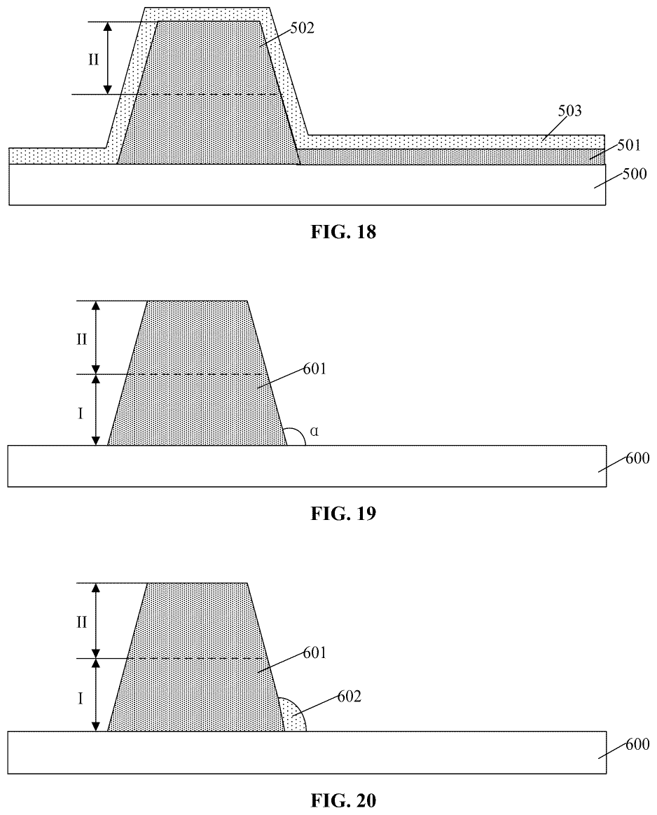

FIG. 18 illustrates a structural schematic of another phase shifter according to various embodiments of the present disclosure.

Referring to FIG. 18, the phase-shifting device may include the first substrate 500; the phase shifter 502 on the first substrate 500, where the phase shifter 502 may include the first portion I and the second portion II, the second portion II may be on the side of the first portion I away from the first substrate 500, the phase shifter 502 may include the first side and the second side which are opposite to each other, the first side may be the side of the first portion I adjacent to the first substrate 500, and the second side may be the side of the second portion II away from the first substrate 500; and further include the conductive layer 501 on the first substrate 500, where the conductive layer 501 may be in electrical contact with a part of the first portion I.

In the phase-shifting device, the conductive layer 501 may be in electrical contact with the first portion I of a part of the phase shifter. Therefore, the region where the conductive layer 501 is in contact with the first portion I of the phase shifter may provide a stress release window for subsequent film stacking, which may avoid the problem of the conductive layer being broken (disconnected) due to the stress mismatch between the conductive layer 501 and other film layers, thereby improving the reliability of the phase-shifting device.

In one embodiment, the conductive layer 501 may be in electrical contact with a part of the first portion I, which may include that the conductive layer 501 is in electrical contact with the sidewall of the first portion I. The conductive layer 501 may be in electrical contact with the sidewall of the first portion I, which may increase the electrical contact area between the conductive layer 501 and the phase shifter 502 and improve the conduction yield of the conductive layer 501 and the phase shifter 502.

In one embodiment, the conductive layer 501 and the phase shifter 502 may be distributed on the surface of the first substrate 500 along the direction in parallel with the surface of the first substrate 500, and the conductive layer 501 may be in contact with the sidewall of the first portion I of the phase shifter 502.

In one embodiment, the material of the conductive layer 501 may be same as the material of the phase shifter 502. The conductive layer 501 and the phase shifter 502 may be formed by one process to save the process.

In one embodiment, the material of the conductive layer 501 and the material of the phase shifter 502 may include a metal or a metal alloy; the metal may include copper, gold or silver; and the metal alloy may include copper molybdenum.

In one embodiment, the phase-shifting device may further include a protective layer 503 on the surface of the first substrate 500, the surface of the conductive layer 501, and the sidewall surface and the top surface of the phase shifter 502.

In one embodiment, the ratio range of the width range of the phase shifter 502 to the width range of the conductive layer 501 may be less than or equal to 10. The thickness range of the phase shifter 502 and the thickness range of the conductive layer 201 may be known. The ratio of the width range of the phase shifter 502 to the width range of the conductive layer 501 may be adjusted, which may ensure that the phase shifter 502 and the conductive layer 501 have desirable conduction performance.

In one embodiment, the ratio of the sheet resistance of the phase shifter 502 to the sheet resistance of the conductive layer 501 may be greater than or equal to 10000, which may ensure that the phase shifter 502 is in desirable contact with the conductive layer 501 to achieve desirable conduction.

In one embodiment, the material of the protective layer 503 may include a dielectric material; and the dielectric constant of the dielectric material may be greater than or equal to 5.

In the phase-shifting device, the conductive layer 501 and the phase shifter 502 may be simultaneously formed in one piece, and the phase shifter 502 may be in direct contact with the conductive layer 501. The phase shifter 502 and the conductive layer 501 may be both conductive materials, and the stress difference may be relatively small. Therefore, when the conductive layer 501 is expanded and contracted during the process to generate stress (pulling), the film layer may be not easily to break, thereby improving the reliability of the phase-shifting device.

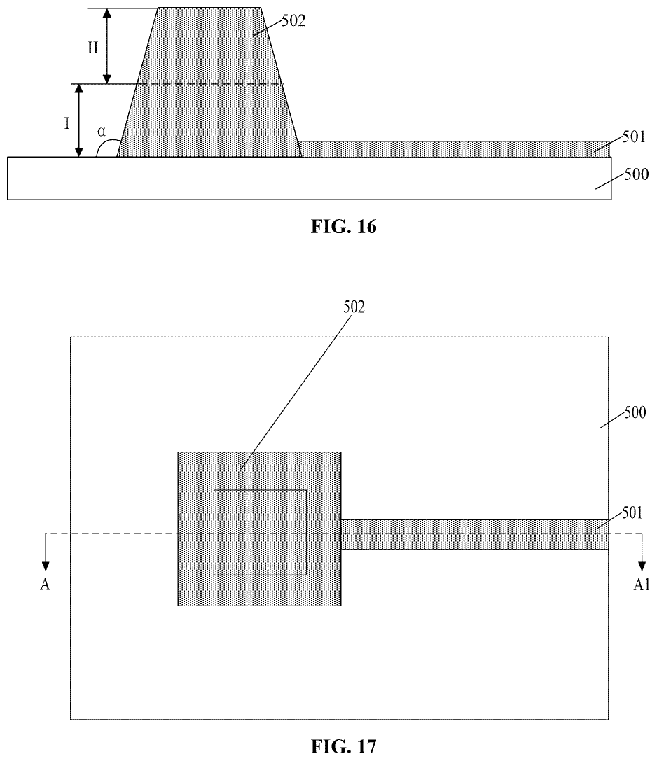

The formation process of the phase-shifting device is described in FIGS. 16-18.

Accordingly, embodiments of the present disclosure further provide a liquid crystal antenna. Referring to FIG. 18, the liquid crystal antenna may include the phase-shifting device as shown in FIG. 18; the second substrate disposed opposite to the first substrate 500, where the second substrate and the first substrate 500 may form a closed space; and the liquid crystal layer between the first substrate 500 and the second substrate.

The reliability of the phase-shifting device may be desirable, and the liquid crystal antenna formed by the phase-shifting device may have a long service life and improve the utilization rate.

The structure of the liquid crystal antenna may refer to the structure in FIG. 24.

FIGS. 16-18 illustrate structural schematics of another phase-shifting device formation process according to various embodiments of the present disclosure.

Referring to FIGS. 16-17, FIG. 16 illustrates a structural schematic of the phase-shifting device along the cross-sectional line AA1 in FIG. 17; and FIG. 17 is a top view of the phase-shifting device in FIG. 16. The first substrate 500 may be provided; and the conductive layer 501 and the phase shifter 502 may be formed on the first substrate 500. The phase shifter 502 may include the first portion I and the second portion II on the first portion I. The second portion II may be on the side of the first portion I away from the first substrate 500. The phase shifter 502 may include the first side and the second side which are opposite to each other. The first side may be the side of the first portion I adjacent to the first substrate 500, and the second side may be the side of the second portion II away from the first substrate 500.

In one embodiment, the conductive layer 501 and the phase shifter 502 may be distributed on the surface of the first substrate 500 along the direction in parallel with the surface of the first substrate 500; and the conductive layer 501 may be in contact with the sidewall of the first portion I of the phase shifter 502.

In one embodiment, the thickness of the conductive layer 501 may be less than or equal to the thickness of the first portion I of the phase shifter 502. The thickness of the phase shifter 502 and the thickness range of the conductive layer 201 may be known. The width range of the phase shifter 502 and the width range of the conductive layer 501 may be adjusted to obtain relatively small conduction resistance. The thickness of the conductive layer 501 may be relatively small, which may save cost while satisfying the conduction requirement.

In one embodiment, the width of the conductive layer 501 may be less than the width of the phase shifter 502. The thickness range of the phase shifter 502 and the thickness range of the conductive layer 201 may be known. The width range of the phase shifter 502 and the width range of the conductive layer 501 may be adjusted to obtain relatively small conduction resistance. The width of the conductive layer 501 may be relatively small, which may save cost while satisfying the conduction requirement.

In one embodiment, the ratio of the width range of the phase shifter 502 to the width range of the conductive layer 501 may be less than or equal to 10. The thickness range of the phase shifter 502 and the thickness range of the conductive layer 201 may be known. The ratio of the width range of the phase shifter 502 to the width range of the conductive layer 501 may be adjusted, which may ensure that the phase shifter 502 and the conductive layer 501 have desirable conduction performance.

In one embodiment, the ratio range of the sheet resistance of the phase shifter 502 to the sheet resistance of the conductive layer 501 may be greater than or equal to 10000, which may ensure that the phase shifter 502 and the conductive layer 501 have desirable contact and conduction.

In one embodiment, the material of the conductive layer 501 may be same as the material of the phase shifter 502.

The material of the conductive layer 501 and the material of the phase shifter 502 may include a metal or a metal alloy; the metal may include copper, gold or silver; and the metal alloy may include copper molybdenum.

In one embodiment, the material of the conductive layer 501 and the material of the phase shifter 502 may include copper.

In one embodiment, the conductive layer 501 and the phase shifter 502 may be formed simultaneously, such that one mask may be saved.

The method for forming the conductive layer 501 and the phase shifter 502 may include forming the metal material layer (not shown in drawings) on the first substrate 500; forming the patterned mask layer (not shown in drawings) on the metal material layer; etching the metal material layer with the patterned mask layer as a mask until the surface of the first substrate 500 is exposed; and forming the conductive layer 501 and the phase shifter 502 on the first substrate 500.

In one embodiment, the process of forming the metal material layer may include a physical vapor deposition process.

In one embodiment, the process of etching the metal material layer may include a dry etching process. The dry etching process may be easy to control the etching direction and etching rate and obtain the conductive layer 501 and the phase shifter 502 with high dimensional accuracy and desirable morphology.

In one embodiment, the material of the patterned mask layer may include photoresist. In other embodiments, the patterned mask layer may further include a hard mask layer at the bottom of the photoresist.

In one embodiment, the angle α between the sidewall of the phase shifter 502 and the surface of the first substrate 500 may be in the range of 90 degrees to 135 degrees. The sidewall of the phase shifter 502 may have a gentle slope, such that the protective layer subsequently formed on the sidewall surface of the phase shifter 502 may have a desirable coverage and extending (slope) performance.

The cross-sectional shape of the phase shifter 502 along the direction perpendicular to the surface of the first substrate 500 may include a rectangle, a trapezoid; or at least one side of the cross-sectional shape may have the angle α with the first substrate 500.

In one embodiment, the cross-sectional shape of the phase shifter 501 along the direction perpendicular to the surface of the first substrate 500 may include a trapezoid.

The conductive layer 501 and the phase shifter 502 may be simultaneously formed in one piece, and the phase shifter 502 may be in direct contact with the conductive layer 501. The phase shifter 502 and the conductive layer 501 may be both conductive materials, the stress difference may be relatively small. Therefore, when the conductive layer 501 expands and contracts during the process to generate stress (pulling), the film layer may be not easily to break, thereby improving the reliability of the phase-shifting device.

Referring to FIG. 18 which is a schematic based on FIG. 16, the protective layer 503 may be formed on the surface of the first substrate 500, the surface of the conductive layer 501, and the sidewall surface and the top surface of the phase shifter 502. The protective layer 503 may be used to protect the phase shifter 502 and the conductive layer 501 from being damaged in subsequent processes.

The process of forming the protective layer 503 may include a chemical vapor deposition process or an atomic layer deposition process.

The material of the protective layer 503 may include a dielectric material, and the dielectric constant of the dielectric material may be greater than or equal to 5. The phase shifter 502 (copper metal) may be below the protective layer 503 for signal phase shifting. Therefore, in order to prevent other metal layers from coupling with the phase shifter 502 to affect the signal, an insulating layer may be needed for separation. The larger the dielectric constant of the protective layer 502 is, the better the insulation effect of the protective layer 502 is.

In one embodiment, the dielectric material may include a silicon-containing material, and the silicon-containing material may include silicon nitride.

In one embodiment, the thickness of the protective layer 503 may be in the range of 500 angstroms to 3000 angstroms.

In one embodiment, the method may further include forming a filling layer (not shown in drawings) on the first substrate 500, and the phase shifter 502 and the conductive layer 501 may be in the filling layer.

The material of the filling layer may include resin. The filling layer may be used to improve the flatness and light transmittance of the surface of the first substrate 500 and have desirable heat resistance and strength to protect the conductive layer 501 from being damaged and improve the service life.

In other embodiments, the filling layer may be not formed.

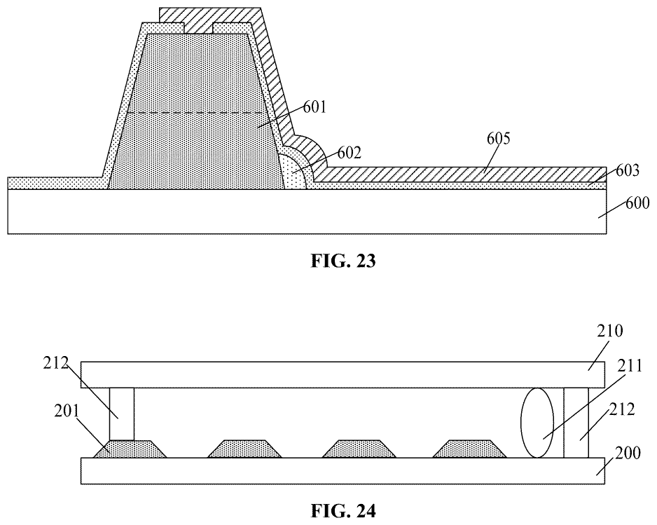

FIG. 23 illustrates a structural schematic of another phase-shifting device according to various embodiments of the present disclosure.

Referring to FIG. 23, the phase-shifting device may include a first substrate 600; a phase shifter 601 on the first substrate 600, where the phase shifter 201 may include the first portion I and the second portion II, the second portion II may be on the side of the first portion I away from the first substrate 600, the phase shifter 601 may include the first side and the second side which are opposite to each other, the first side may be the side of the first portion I adjacent to the first substrate 600, and the second side may be the side of the second portion II away from the first substrate 600; the protective layer 603 on the surface of the first substrate 600, the sidewall surface of the phase shifter 601 and the second side; a buffer structure 602 between the sidewall surface of the first portion I of the phase shifter 601 and the protective layer 603; and a conductive layer 605 on the surface of the protective layer 603, where the conductive layer 605 may be electrically connected to the phase shifter 601.

In the phase-shifting device, the buffer structure 602 may be between the sidewall surface of the first portion I of the phase shifter and the protective layer 603, and the buffer structure 602 may be at the connecting position of the first substrate 600 and the sidewall of the phase shifter. Therefore, when the conductive layer 605 expands and contracts during the process and causes stress (pulling) on the protective layer, the buffer structure 602 may provide a stress release window for the protective layer 603, such that the protective layer 603 may be not easy to cause the film layer to break due to the stress mismatch with the phase shifter 601, and it may prevent the leakage of the etching liquid when the conductive layer 605 is formed during etching which may cause the conductive layer 605 to break, thereby improving the reliability of the phase-shifting device.

In one embodiment, the phase-shifting device may further include a groove in the protective layer 603 on the second side of the phase shifter 601, the groove may expose a part of the surface of the phase shifter 601 on the second side, and the conductive layer 605 may be also in the groove, and the conductive layer 605 may be electrically connected to the second side of the phase shifter 601. The conductive layer 605 in the second groove may be used to be electrically connected to the phase shifter 601.

In one embodiment, the conductive layer 605 may be on a surface of a part of the protective layer 603 and extend from the top of the phase shifter 601, along a sidewall of the phase shifter 601, to the surface of the first substrate 600.

In one embodiment, the buffer structure 602 may be on the sidewall surface of the first portion I at the bottom of the conductive layer 605 and also on a part of the surface of the first substrate 600. The buffer structure 602 may extend from the sidewall of the first portion I to the surface of the first substrate 600, such that the transition slope of the protective layer 603 and the conductive layer 605, on the surface of the buffer structure 602, from the surface of the first substrate 600 to the sidewall surface of the phase shifter 601 may be relatively gentle, and the buffer structure 602 may provide a stress release window for the protective layer 603, while ensuring the continuity of the film layer.

In one embodiment, the elastic modulus of the material of the buffer structure 602 may be greater than the elastic modulus of the material of the protective layer 603. Therefore, when the conductive layer 605 expands and contracts due to thermal expansion and contraction and causes stress (pulling) on the protective layer 603, the buffer structure 602 may have a relatively large deformation, which may provide a relatively large deformation space for the protective layer 603, such that the stress of the protective layer 603 may be released.

In one embodiment, the material of the buffer structure 602 may be different from the material of the protective layer 603, such that the material of the buffer structure 602 and the material of the protective layer 603 may have different elastic moduli.

In one embodiment, the material of the protective layer 603 may include a dielectric material, the dielectric constant of the dielectric material may be greater than or equal to 5, the dielectric material may include a silicon-containing material, and the silicon-containing material may include silicon nitride.

In one embodiment, the material of the buffer structure 602 may include an organic material, and the organic material may include resin or photoresist.

In one embodiment, the buffer structure 602 may include one or more buffer layers.

In one embodiment, the material of the phase shifter 601 may be different from the material of the conductive layer 605.

In one embodiment, the material of the phase shifter 601 may include a metal or a metal alloy, the metal may include copper, gold or silver, and the metal alloy may include copper molybdenum.

In one embodiment, the material of the conductive layer 605 may include a conductive material, and the conductive material may include indium tin oxide, aluminum-doped zinc oxide, or fluorine-doped tin oxide.

In one embodiment, the phase-shifting device may further include a filling layer on the first substrate 600; and the phase shifter 601 and the conductive layer 605 may be in the filling layer.

In the phase-shifting device, the buffer structure 602 may be at the connecting position of the first substrate 600 and the sidewall of the phase shifter 601. Therefore, when the conductive layer 605 expands and contracts during the process and causes stress (pulling) on the protective layer 603, the buffer structure 602 may provide a stress release window for the protective layer 603, such that the protective layer 603 may be not easy to cause the film layer to break due to the stress mismatch with the phase shifter 601, and it may prevent the leakage of the etching liquid when the conductive layer 605 is formed during etching which may cause the conductive layer 605 to break, thereby improving the reliability of the phase-shifting device.

The formation process of the phase-shifting device is described in FIGS. 19-23.

Accordingly, embodiments of the present disclosure further provide a liquid crystal antenna. Referring to FIG. 23, the liquid crystal antenna may include the phase-shifting device as shown in FIG. 23; the second substrate disposed opposite to the first substrate 600, where the second substrate and the first substrate 400 may form a closed space; and the liquid crystal layer between the first substrate 600 and the second substrate.

The reliability of the phase-shifting device may be desirable, and the liquid crystal antenna formed by the phase-shifting device may have a long service life and improve the utilization rate.

FIGS. 19-23 illustrate structural schematics of another phase-shifting device formation process according to various embodiments of the present disclosure.

Referring to FIG. 19, the first substrate 600 may be provided; and the phase shifter 601 may be formed on the first substrate 600, where the phase shifter 201 may include the first portion I and the second portion II, the second portion II may be on the side of the first portion I away from the first substrate 600, the phase shifter 601 may include the first side and the second side which are opposite to each other, the first side may be the side of the first portion I adjacent to the first substrate 600, and the second side may be the side of the second portion II away from the first substrate 600.

In one embodiment, the angle α between the sidewall of the phase shifter 601 and the surface of the first substrate 600 may be in the range of 90 degrees to 135 degrees. The sidewall of the phase shifter 601 may have a gentle slope, which may be conveniently for the conductive layer formed subsequently to extend from the second side of the phase shifter 601, along the sidewall of the phase shifter 201, to the surface of the first substrate 600, such that the film layer formed on the sidewall surface of the phase shifter 601 may have a desirable coverage and extending (slope) performance.

The cross-sectional shape of the phase shifter 601 along the direction perpendicular to the surface of the first substrate 600 may include a rectangle or a trapezoid; or at least one side of the cross-sectional shape may have the angle α with the first substrate 600.

In one embodiment, the cross-sectional shape of the phase shifter 601 along the direction perpendicular to the surface of the first substrate 600 may include a trapezoid.

The material of the phase shifter 601 may include a metal or a metal alloy, the metal may include copper, gold or silver, and the metal alloy may include copper-molybdenum.

In one embodiment, the material of the phase shifter 601 may include copper-molybdenum.

The copper material may have desirable conductivity and low resistance, which may reduce signal loss; molybdenum may have desirable adhesion to the glass substrate and used a connecting layer between the copper metal and the glass substrate to prevent the copper metal device from falling off.

In other embodiments, the copper material with desirable conductivity and low resistance may be replaced by silver or gold.

The method for forming the phase shifter 601 may include forming the metal material layer (not shown in drawings) on the first substrate 600; forming the patterned mask layer (not shown in drawings) on the metal material layer; etching the metal material layer with the patterned mask layer as a mask until the surface of the first substrate 600 is exposed; and forming the phase shifter 201 on the first substrate 600.

In one embodiment, the process of forming the metal material layer may include a physical vapor deposition process.

In one embodiment, the process of etching the metal material layer may include a dry etching process. The dry etching process may be easy to control the etching direction and etching rate and obtain the phase shifter 601 with high dimensional accuracy and desirable morphology.

In one embodiment, the material of the patterned mask layer may include photoresist. In other embodiments, the patterned mask layer may further include a hard mask layer at the bottom of the photoresist.

In one embodiment, the material of the first substrate 600 may include glass. The glass material may have desirable light transmittance, which may facilitate light to pass through the material of the first substrate 600. Glass may include soda-lime glass, borosilicate glass and/or the like.

In other embodiments, the material of the first substrate may also be a PCB board, a silicon wafer, a flexible PI film board and the like.

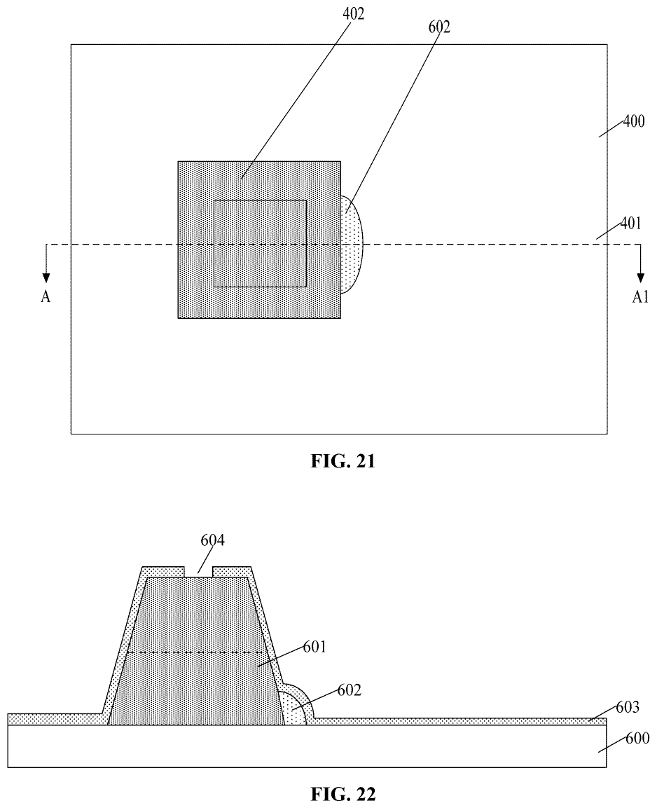

Referring to FIGS. 20-21, FIG. 20 illustrates a structural schematic of the phase-shifting device along the cross-sectional line AA1 in FIG. 21; and FIG. 21 is a top view of the phase-shifting device in FIG. 20. The buffer structure 602 may be formed on the sidewall surface of the first portion I of the phase shifter 601.

The buffer structure 602 may include one or more buffer layers.

The material of the buffer structure 602 may include an organic material, and the organic material may include resin or photoresist.

The method for forming the buffer structure 602 may include forming a buffer material layer (not shown in drawings) on the sidewall surface of the first portion I of the phase shifter 601; and solidifying the buffer material layer to form the buffer structure 602 on the sidewall surface of the first portion I of the phase shifter 601.

The process of forming the buffer material layer may include a dot coating process; and the process of solidifying the buffer material layer may include thermal solidification or ultraviolet solidification.

In one embodiment, the height of the buffer structure 602 may be less than or equal to the thickness of the first portion I of the phase shifter 601.

In other embodiments, the height of the buffer structure may be greater than the thickness of the first portion of the phase shifter.

In one embodiment, the thickness range of the buffer structure 602 may be 3000 angstroms to 10000 angstroms. The buffer material in such thickness range may form a uniform slope, which may facilitate the smooth transition of the conductive layer (line).

Referring to FIG. 22, the protective layer 603 may be formed on the surface of the first substrate 600, the sidewall surface of the phase shifter 601, and the second side; and the buffer structure 602 may be between the sidewall of the first portion I and the protective layer 603.

In one embodiment, the method may further include forming a groove 604 in the protective layer 603 on the second side of the phase shifter 601, where the groove 604 may expose a part of the surface of the phase shifter 601 on the second side.

The formation process of the groove 604 and the protective layer 603 may include forming the protective material layer (not shown in drawings) on the surface of the first substrate 600, the sidewall surface and the surface of the phase shifter 601 on the second side, and the surface of the buffer structure 602; forming the patterned mask layer (not shown in drawings) on the protective material layer; etching the protective material layer with the patterned mask layer as a mask until the surface of the phase shifter 601 on the second side is exposed; and forming the groove 604 in the protective layer 603 on the second side of the phase shifter 601.

The process of forming the protective material layer may include a chemical vapor deposition process or an atomic layer deposition process.

In one embodiment, the process of etching the protective material layer may include a dry etching process.

In one embodiment, the material of the buffer structure 602 may be different from the material of the protective layer 603.

The material of the protective layer 603 may include a dielectric material, and the dielectric constant of the dielectric material may be greater than or equal to 5. The phase shifter 601 (copper metal) may be below the protective layer 603 for signal phase shifting. Therefore, in order to prevent other metal layers from coupling with the phase shifter 601 to affect the signal, an insulating layer may be needed for separation. The larger the dielectric constant of the protective layer 603 is, the better the insulation effect of the protective layer 603 is.

In one embodiment, the dielectric material may include a silicon-containing material, and the silicon-containing material may include silicon nitride.

In one embodiment, the elastic modulus of the buffer structure 602 material may be greater than the elastic modulus of the protective layer 603 material. Therefore, in subsequent process of forming the conductive layer, when the conductive layer expands and contracts due to thermal expansion and contraction and causes stress (pulling) on the protective layer 603, the buffer structure 602 may have relatively large deformation, which may provide a relatively large deformation space for the protective layer 603, such that the stress of the protective layer 603 may be released.

In one embodiment, the thickness range of the protective layer 603 may be 500 angstroms to 3000 angstroms.

Referring to FIG. 23, the conductive layer 605 may be formed on the surface of the protective layer 603 and electrically connected to the phase shifter 601.

In one embodiment, the conductive layer 605 may be also in the groove 604 and electrically connected to the second side of the phase shifter 601.

In one embodiment, the conductive layer 605 may be on a part of the surface of the protective layer 603 and extend from the top of the phase shifter 601, along a sidewall of the phase shifter 601, to the surface of the first substrate 600.

In one embodiment, the buffer structure 602 may be on the sidewall surface of the first portion I at the bottom of the conductive layer 605 and on a part of the surface of the first substrate 600. That is, when the conductive layer 605 extends from the second side of the phase shifter 601, along a sidewall of the phase shifter 601, to the surface of the first substrate 600, the buffer structure 602 may be in the extension direction of the conductive layer 605.

In one embodiment, the material of the phase shifter 601 may be different from the material of the conductive layer 605.

The material of the conductive layer 605 may include a conductive material; and the conductive material may include indium tin oxide, aluminum-doped zinc oxide, or fluorine-doped tin oxide.

In one embodiment, the material of the conductive layer 605 may include indium tin oxide.

In other embodiments, the material of the conductive layer may be same as the material of the phase shifter.

The method for forming the conductive layer 605 may include forming the conductive material layer (not shown in drawings) on the surface of the protective layer 603 and in the groove 604; forming the patterned mask layer (not shown in drawings) on the surface of the conductive material layer; etching the conductive material layer with the patterned mask layer as a mask until the surface of the protective layer 603 is exposed; and forming the conductive layer 605 on the surface of the protective layer 603 and in the groove 604.

In one embodiment, the process of forming the conductive material layer may include a magnetron sputtering coating process.

In one embodiment, the process of etching the conductive material layer may include a wet etching process.

In one embodiment, the material of the patterned mask layer may include photoresist. In other embodiments, the patterned mask layer may further include a hard mask layer at the bottom of the photoresist.

The angle α between the sidewall of the phase shifter 601 and the surface of the first substrate 600 may be in the range of 90 to 135 degrees. The sidewall of the phase shifter 601 may have a gentle slope. When the conductive layer 605 extends from the second side of the phase shifter 601, along the sidewall of the phase shifter 601, to the surface of the first substrate 600, the conductive layer 605 may have desirable coverage and extending (slope) performance on the sidewall surface of the phase shifter 601.

The buffer structure 602 may be at the connecting position of the first substrate 600 and the sidewall of the phase shifter 601. Therefore, when the conductive layer 605 expands and contracts during the process and causes stress (pulling) on the protective layer 603, the buffer structure 602 may provide a stress release window for the protective layer 603, such that the protective layer 603 may be not easy to cause the film layer to break due to the stress mismatch with the phase shifter 601, and it may prevent the leakage of the etching liquid when the conductive layer 605 is formed during etching which may cause the conductive layer 605 to break, thereby improving the reliability of the phase-shifting device.

In one embodiment, the method may also include forming a filling layer (not shown in drawings) on the first substrate 600, where the phase shifter 601 and the conductive layer 605 may be in the filling layer.

The material of the filling layer may include resin. The filling layer may be used to improve the flatness and light transmittance of the surface of the first substrate 600 and have desirable heat resistance and strength to protect the conductive layer 605 from being damaged and improve the service life.

In other embodiments, the filling layer may be not formed.

It may be seen from above-mentioned embodiments that the present disclosure may at least achieve following beneficial effects.

For the phase-shifting device and the formation method of the phase-shifting device, the conductive layer may be in electrical contact with the first portion of a part of the phase shifter, such that may be provided for subsequent film stacking in the region where the conductive layer is in contact with the first portion of the phase shifter, which may avoid the problem of the conductive layer being broken (disconnected) due to the stress mismatch between the conductive layer and other film layers, thereby improving the reliability of the phase-shifting device.

Although the present disclosure is disclosed as above, the present disclosure may be not limited thereto. Those skilled in the art may make various changes and modifications without departing from the spirit and scope of the present disclosure. Therefore, the protection scope of the present disclosure shall be based on the scope defined by the claims.

What is claimed is

1. A phase-shifting device, comprising:
a first substrate;
a phase shifter, on the first substrate, wherein the phase shifter includes a first portion and a second portion; the second portion is on a side of the first portion away from the first substrate;
the phase shifter includes a first side and a second side which are opposite to each other; and the first side is a side of the first portion adjacent to the first substrate, and the second side is a side of the second portion away from the first substrate; and
a conductive layer, on the first substrate, wherein the conductive layer is in an electrical contact with a part of the first portion.

2. The phase-shifting device according to claim 1, wherein:
the conductive layer being in the electrical contact with the part of the first portion includes the conductive layer being in the electrical contact with a sidewall of the first portion.

3. The phase-shifting device according to claim 2, further including:
a protective layer, on a side of the first substrate adjacent to the phase shifter, wherein the protective layer covers the phase shifter and a part of the first substrate; the protective layer includes a first groove; the first groove exposes a sidewall surface of a part of the first portion, and further exposes a part of the first substrate adjacent to the side of the phase shifter; the conductive layer is on a side of the protective layer away from the first substrate; and the conductive layer is also in the first groove.

4. The phase-shifting device according to claim 3, wherein:
the protective layer further includes a second groove, wherein the second groove exposes a part of a surface of the second side, and the conductive layer is in the second groove and electrically connected to the second side.

5. The phase-shifting device according to claim 3, wherein:
a width of the conductive layer is less than a width of the first groove.

6. The phase-shifting device according to claim 3, wherein:
the first groove surrounds the phase shifter.

7. The phase-shifting device according to claim 3, wherein:
the first groove exposes a sidewall surface of a part of the first portion on a side of the phase shifter.

8. The phase-shifting device according to claim 2, wherein:
the conductive layer and the phase shifter are distributed on a surface of the first substrate along a direction in parallel with the surface of the first substrate; and the conductive layer is in a contact with the sidewall of the first portion of the phase shifter.

9. The phase-shifting device according to claim 8, wherein:
a material of the conductive layer is same as a material of the phase shifter.

10. The phase-shifting device according to claim 1, wherein:
the conductive layer being in the electrical contact with the part of the first portion includes the conductive layer being in the electrical contact with the first side of the phase shifter.

11. The phase-shifting device according to claim 10, wherein:
the conductive layer is on a side of the first substrate adjacent to the phase shifter, and the phase shifter is on a side of the conductive layer away from the first substrate; and the phase shifter further includes a protective layer covering a surface of the phase shifter and a surface of a part of the conductive layer.

12. The phase-shifting device according to claim 11, wherein:
a material of the conductive layer is different from a material of the phase shifter.

13. The phase-shifting device according to claim 11, wherein:
a material of the conductive layer is same as a material of the phase shifter.

14. The phase-shifting device according to claim 2, wherein:
a material of the conductive layer is different from a material of the phase shifter.

15. The phase-shifting device according to claim 8, wherein:
a width of the phase shifter is greater than a width of the conductive layer.

16. The phase-shifting device according to claim 10, wherein:
a width of the phase shifter is greater than a width of the conductive layer.

17. The phase-shifting device according to claim 15, wherein:
a ratio of a sheet resistance of the phase shifter to a sheet resistance of the conductive layer is greater than or equal to 10000.

18. The phase-shifting device according to claim 1, wherein:
an angle between a sidewall of the phase shifter and a surface of the first substrate is in a range of 90 degrees to 135 degrees.

19. The phase-shifting device according to claim 1, further including:
a filling layer on the first substrate, wherein the phase shifter and the conductive layer are in the filling layer.

20. A liquid crystal antenna, comprising:
a phase-shifting device, comprising:
a first substrate;
a phase shifter, on the first substrate, wherein the phase shifter includes a first portion and a second portion; the second portion is on a side of the first portion away from the first substrate; the phase shifter includes a first side and a second side which are opposite to each other; and the first side is a side of the first portion adjacent to the first substrate, and the second side is a side of the second portion away from the first substrate; and
a conductive layer, on the first substrate, wherein the conductive layer is in an electrical contact with a part of the first portion;
a second substrate disposed opposite to the first substrate, wherein the second substrate and the first substrate form a closed space; and
a liquid crystal layer, between the first substrate and the second substrate.
